(19) United States
(12) Patent Application Publication
(10) Pub. No.: US 2002/0163573 A1
(43) Pub. Date: Nov. 7, 2002

(54) Imaging system

(76) Inventors: Leonard H. Bieman, Farmington Hills, MI (US); Gary Rutledge, Clarkston, MI (US)

Correspondence Address: DAVID M. LAPRAIRIE, ESQ., HOWARD & HOWARD, 39400 Woodward Avenue, Suite 101, Bloomfield Hills, MI, 48304-5151, US

(21) Appl. No.: 09/832,710

(22) Filed: Apr. 11, 2001

(51) Int. Cl. H04N 13/02

(52) U.S. Cl. 348/46; 348/131; 382/154; 348/52

(57) ABSTRACT

An imaging system for creating a three dimensional image of an object. The imaging system includes a housing and three sets of light sources mounted to the housing. The light sources are selectively illuminated for projecting light on the object. A camera is spaced from the housing for capturing projected light reflecting from the object. A lens and a diffuser are mounted to the housing and are spaced from the light sources for focusing and blurring the projected light to define an image projected upon the object. A controller is connected to the light sources for sequentially illuminating the light sources to produce at least three different images on the object. The controller is also connected to the camera for controlling the camera to capture the different images for creating the three dimensional image of the object.

### BACKGROUND OF THE INVENTION

1) Technical Field

The subject invention relates to an imaging system used in creating a three dimensional image of an object.

2) Description of the Prior Art

Using Phase Shifting Interferometry to create a three dimensional image of an object is well known in the art, and typically includes a light source, a grating, and a lens which are used to project an image of the grating onto the object. A camera is then used to reimage the pattern and create the three dimensional image.

In particular, this method of creating a three dimensional image requires the viewing of three or more different projected patterns on the object. The projected pattern in each image is shifted to create three images of the object with unique light patterns projected on the object. By knowing the shift between the projected patterns, and using trigonometric equations based on the distances between the light source, grating, lens, object, and camera, a processor within the camera creates a three dimensional bit-map of the object.

The most common way of shifting the projected pattern from one image to the other has been to move the grating. U.S. Pat. No. 5,646,733 to Bieman, and U.S. Pat. No. 4,212,073 to Balasubramanian disclose this method of shifting the grating pattern. This can be achieved by attaching the grating to a servomotor or some other suitable means to move the grating.

Other methods project light through clear substrates having multiple bands of liquid crystal, as disclosed in U.S. Pat. No. 5,581,352 to Zeien. The bands of liquid crystal are selectively activated to create varying shadow patterns as the light is projected through them.

Still yet another method involves the use of a grating in combination with a clear glass plate, as disclosed in U.S. Pat. No. 5,471,308 to Zeien. The glass plate is rotated on an axis by way of a servomotor. The result is to cause the shadow of the grating to shift as it is projected through the lens. Although simple enough to achieve, these prior art methods have historically made three-dimensional imaging systems costly. The additional equipment needed to facilitate the movement of components in the systems described above also makes the systems bulky and not appropriate for applications where the system must be compact and mobile. Waiting for the mechanical movement to shift the grating shadow also adds time to the process.

An improvement contemplated by the prior art is disclosed in U.S. Pat. No. 6,122,062 to Bieman, which utilizes a matrix of light sources for projecting light through a grating. The matrix of light sources has at least three rows of lights wherein the rows can be sequentially illuminated to project different shadows on the object. This improved system eliminates the need for moving parts, such as moving the grating or the light source. This design, however, uses a grating to create shadows on the object. Shadow casting inherently has a number of deficiencies. In particular, shadow casting cannot change the cone angle of the light pattern being projected from the light sources. In other words, gratings cannot increase or decrease the width of the light pattern for larger or smaller objects. In addition, only half of the projected light passes through a grating and onto an object. Hence, additional or higher intensity light sources must be used. Further, the grating must be adequately spaced from the light source or no phase shift will be realized. This requires the user to be particularly aware of the spacing between the light sources, grating, and the object.

Accordingly, it would be desirable to develop an imaging system which does not require moving parts nor the need for shadow casting while still being able to accurately create a three dimensional image of the object.

### SUMMARY OF THE INVENTION AND ADVANTAGES

An imaging system for creating a three dimensional image of an object. The imaging system comprises a housing and at least three light sources mounted to the housing. The light sources can be selectively illuminated for projecting light on the object. A camera is spaced from the housing for capturing projected light reflecting from the object. An imaging device is mounted to the housing and is spaced from the light sources for focusing the projected light to define an image projected upon the object. A controller is connected to the light sources for sequentially illuminating the light sources to produce at least three different images on the object. The controller is also connected to the camera for controlling the camera to capture the different images for creating the three dimensional image of the object.

Accordingly, the subject invention provides for an imaging system which can create a three dimensional image of the object without the use of a grating or any moving parts.

The present invention creates shifted images on an object that is to be three dimensionally imaged in a quick and cost effective manner which will also allow the overall system to remain compact and thereby appropriate for applications where the system must be portable and moveable. The present invention uses a matrix of light sources to create multiple images on an object. Preferably, different rows of the matrix are sequentially illuminated to create spaced images on the object almost instantly. There is no additional time spent to allow a part, such as a grating, to be moved, or to allow liquid crystal bands to be activated and deactivated. Since there are no moving parts to the system, the present invention can be set-up easily and is portable. Once this is done, the system can be moved to different locations or even mounted onto a machine to be used on a moving line, or robotic application.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic diagram of the imaging system;

FIG. 2 is a front view of a housing having a matrix of light sources;

FIG. 3 is a partially cross sectional side view of the housing illustrating the light sources and a lens;

FIG. 4 is an enlarged cross sectional side view of the lens;

FIG. 5 is a perspective view of the lens;

FIG. 6 is a perspective view of a diffuser;

FIG. 7 is a schematic front view of the matrix of light sources illustrating a first set of rows being illuminated to create a first image on an object;

FIG. 8 is a schematic front view of the matrix of light sources illustrating a second set of rows being illuminated to create a second image on an object;

FIG. 9 is a schematic front view of the matrix of light sources illustrating a third set of rows being illuminated to create a third image on an object

FIG. 10 is a schematic side view of the light sources and the lens illustrating the focusing and refractive properties of the lens; and

FIG. 11 is a schematic diagram of the imaging system illustrating three light patterns projecting three different images onto an angled plate.

### DETAILED DESCRIPTION OF THE PREFERRED EMBODIMENT

Referring to the Figures, wherein like numerals indicate like or corresponding parts throughout the several views, an imaging system 20 is schematically shown in FIG. 1. The imaging system 20 is designed to create a three dimensional image of an object 22. For illustrative purposes, the object 22 is shown as a generic irregularly shaped object 22.

In particular, the imaging system 20 includes at least three light sources 24. Preferably there are a plurality of light sources 24 arranged in at least three rows to define a matrix of light sources 24. As shown best in FIGS. 7-9, there are preferably twenty-seven horizontal rows of light sources 24. Each horizontal row is shown as having three discreet light sources 24 defined by light emitting diodes 26 (LEDs). The LEDs 26 preferably emit infrared light. The LED 26 light sources 24 are relatively inexpensive and once the light matrix has been formed, will not require any movement. This reduces the amount of equipment in the system 20, as there is no need for any mechanical movement.

The horizontal rows of light sources 24, however, may also be defined as a light stripes such as slab diode lasers or long filament incandescent lamps which emit a line of light. In addition, the rows of light sources 24 could be discreet point light sources defined by laser diodes. As will be discussed in greater detail below, the light sources 24 can be sequentially illuminated to project different images onto the object 22. It should be appreciated, that there may be any number of light sources 24 orientated in any suitable configuration and orientation which may be of any suitable design or configuration so long as at least three different bands of light can be projected upon the object 22.

Referring back to FIG. 1, the imaging system 20 also includes a camera 28 for capturing projected light reflecting from the object 22. The camera 28 may be a still or video camera of any suitable design or configuration as is known in the photography and filming art.

A sensor 30 is mounted within the camera 28 for viewing the object 22 and capturing each of the images produced by the matrix of light sources 24. The sensor 30 may be any suitable device such as a two-dimensional imaging array. Alternatively, the sensor 30 may be a line scan sensor defining a one-dimensional imaging array for producing a bit map along a single line. Further, the sensor 30 may include a single detector for producing a bit map at a single point. A processor 32 is interconnected to the camera 28 for converting the images of the object 22 projected thereon into a three-dimensional bit map of the object 22. The processor 32 may also include a memory for storing the three dimensional images of the object 22.

A controller 34 is connected to the light sources 24 for sequentially illuminating the light sources 24 to produce at least three different images on the object 22. The controller 34 is also connected to the camera 28 for controlling the camera 28 to capture the different images for creating the three dimensional image of the object 22. Preferably the controller 34 is a computer 34 which interfaces with both the light sources 24 and the camera 28. It should be appreciated that the processor 32 may be mounted to or be an integral part of the computer 34 as is known in the art.

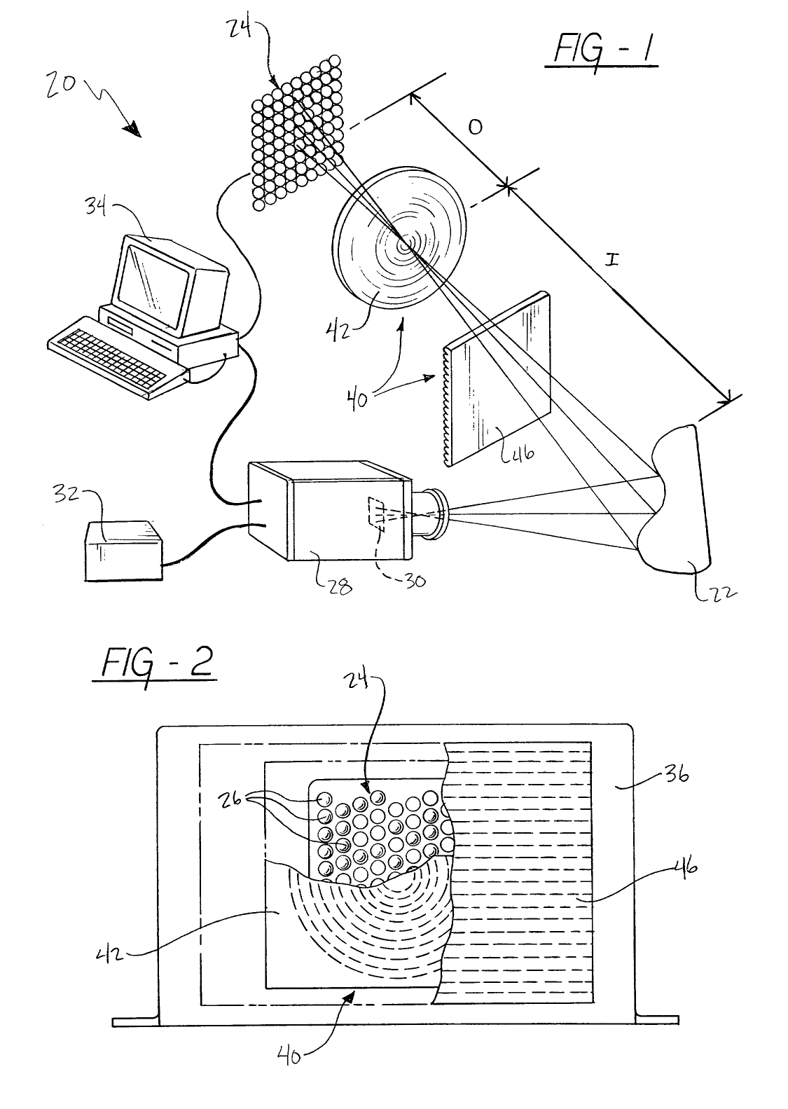

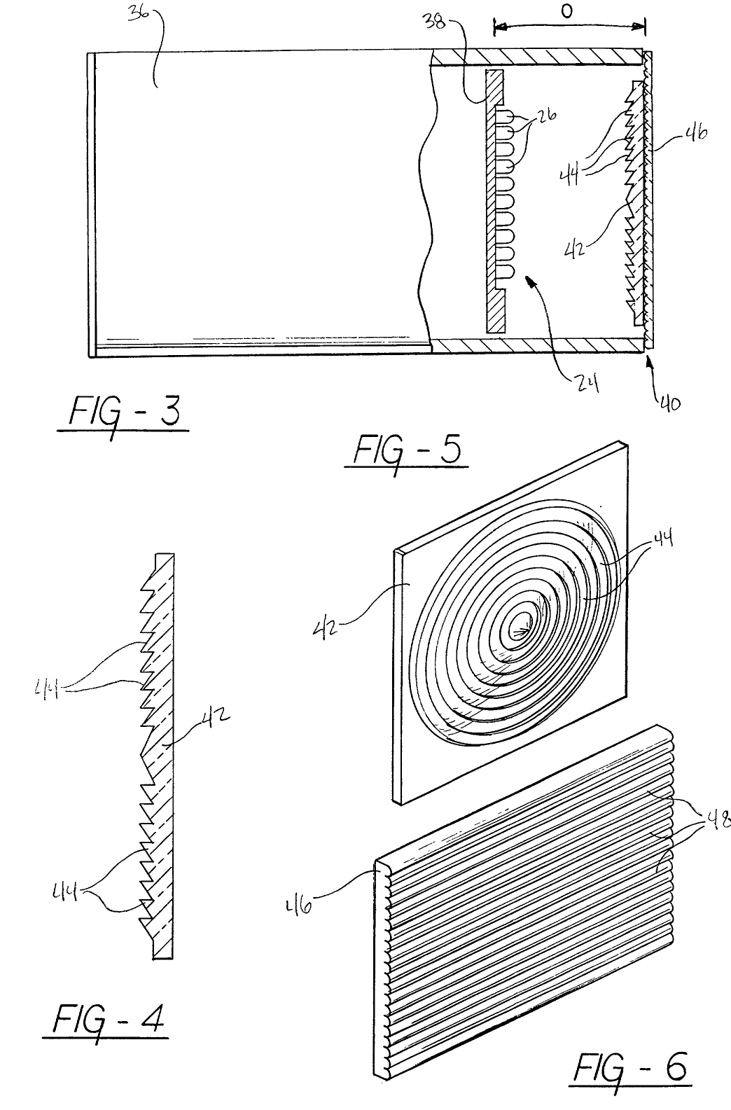

Referring also to FIGS. 2 and 3, the imaging system 20 includes a housing 36 with the light sources 24 mounted to the housing 36. In particular, the illustrated LEDs 26 are mounted to a suitable support structure 38 within the housing 36.

An imaging device 40 is mounted to the housing 36 and spaced from the light sources 24 for focusing the projected light to define an image projected upon the object 22. The imaging device 40 is spaced at a predetermined distance and position relative to the light sources 24 which is shown as distance O. The distance O, however, is not as critical as in the prior art grating systems such that the housing 36 and overall assembly may vary in size. Another important distance is the relative distance between the imaging device 40 and the object 22, which is shown as distance I. The relative distances between the light sources 24, imaging device 40, and object 22 are discussed in greater detail below.

The imaging device 40 includes a lens 42 mounted to the housing 36 for focusing the projected light to create the image. The use of lenses is particularly advantageous in that the lens 42 provides additional flexibility in positioning the imaging device 40 relative to the object 22. In addition, larger and smaller sized objects can be imaged using lenses having different reflective characteristics. Hence, during the design phase of the imaging system 20, a variety of lenses can be used based upon the proposed usage of the imaging system 20 and size of the object 22. In addition, it may be possible to substitute one type of lens for another if the proposed usage or object size changes.

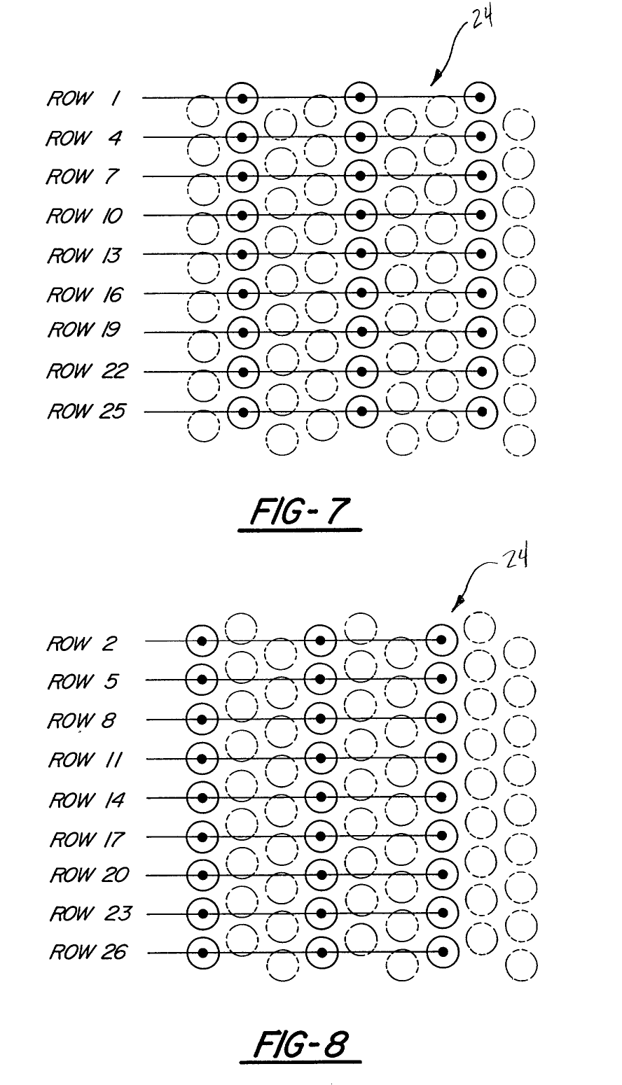

As also shown in FIGS. 4 and 5, the lens 42 is preferably a fresnel lens 42 having a series of concentric grooves 44 which act as individual refracting surfaces. The particular type of fresnel lens 42 is chosen based upon a number of factors. Some factors include the particular focal length F of the lens 42 and the diameter of the lens 42. Focal lengths F are chosen based upon the relative distances of the imaging device 40 to the light sources 24, distance O, and the object 22 to the imaging device 40, distance I. The following formula can be used to determine the focal length F of the lens 42 based upon the expected distances;

$$\frac{1}{O} + \frac{1}{I} = \frac{1}{F}$$

As shown in FIG. 3, the fresnel lens 42 may be mounted to the housing 36 such that the grooves 44 face inward toward the light sources 24. Alternatively, the fresnel lens 42 can be mounted to the housing 36 such that the grooves 44 face outward away from the light sources 24.

The imaging device 40 also includes a diffuser 46 for blurring the image projected onto the object 22. Light projecting through the lens 42 is focused into a particular image. In the preferred embodiment, it is advantageous to blur the image to clarify a pattern of the image as is discussed in greater detail below. As also shown in FIG. 6, the diffuser 46 is further defined as a lenticular lens having an array of aligned cylindrical lenses 48, as viewed in cross section. The diffuser 46 is preferably mounted to the housing 36 such that the cylindrical lenses 48 face inward toward the light sources 24. The illustration in FIG. 1 of the diffuser 46 being spaced from the lens 42 is purely for descriptive purposes and the diffuser 46 is actually mounted adjacent the lens 42 such as shown in FIG. 3. It should be appreciated that any suitable type of diffuser 46 could be used to blur the image. Further, depending upon the type of lens 42, the diffuser 46 may be eliminated altogether.

The operation of the preferred embodiment of the subject invention having a matrix of light emitting diodes 26 is now discussed in greater detail with reference to FIGS. 7-10. It should be noted that the subject operation is substantially the same when using alternative light sources 24, lenses 42, and/or diffusers 46.

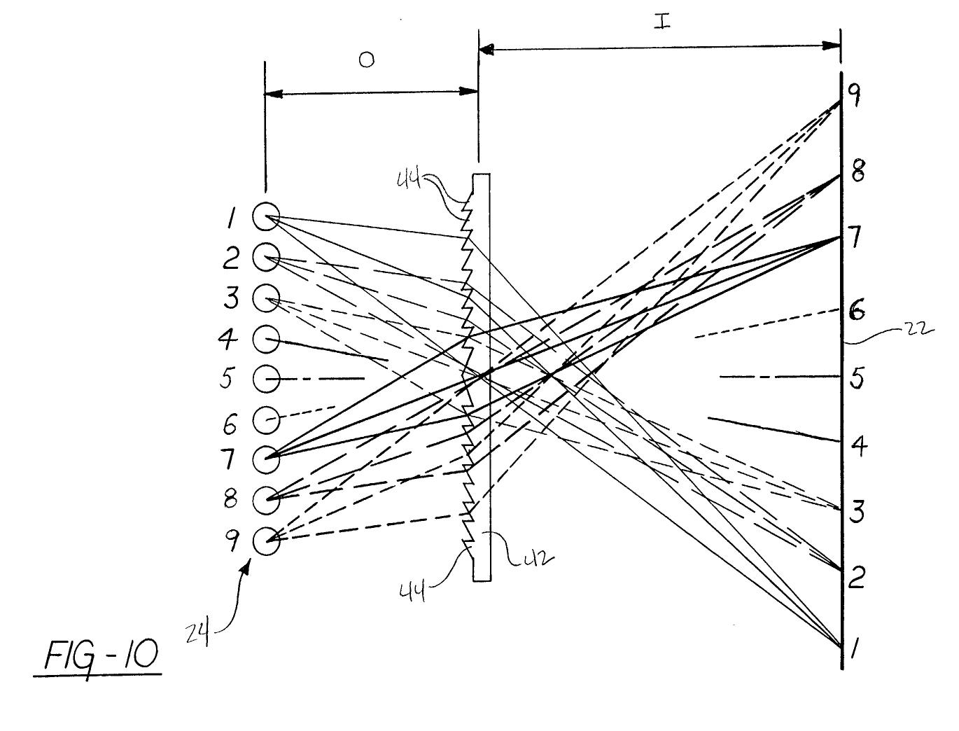

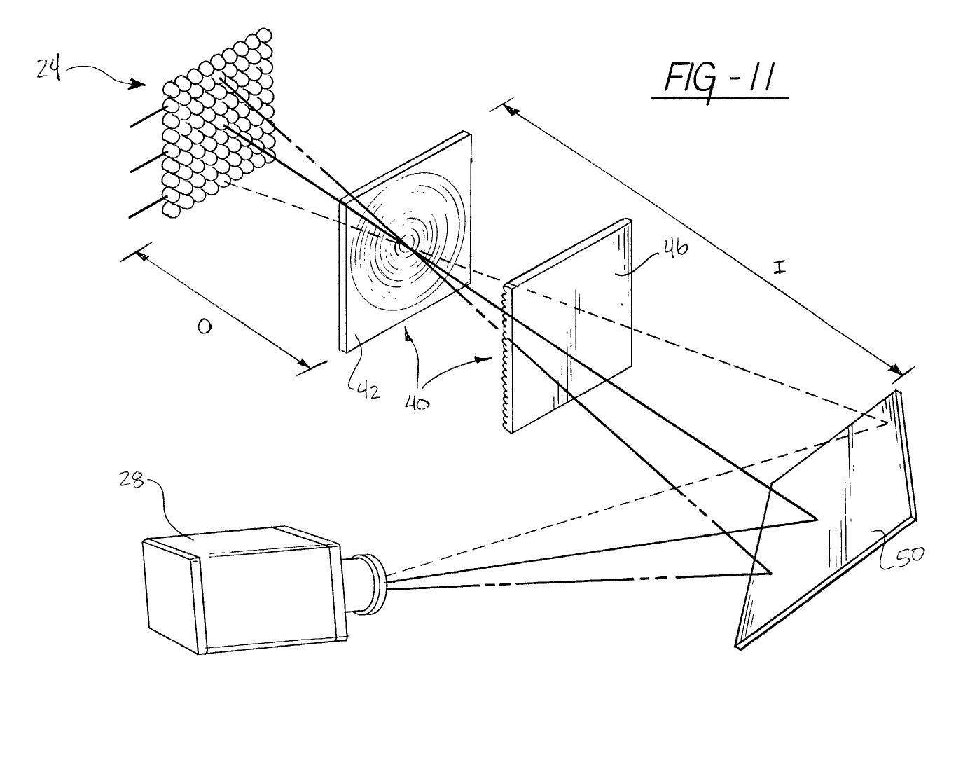

Initially a first row of light emitting diodes 26 are illuminated to project light toward the lens 42. As shown in FIGS. 7 and 10, in the preferred embodiment, the three infrared light emitting diodes 26 of the first row are illuminated as well as the three infrared light emitting diodes 26 in every third row thereafter. Hence, the 1^{st}, 4^{th}, 7^{th}, 10^{th}, 13^{th}, 16^{th}, 19^{th}, 22^{nd}, and 25^{th} rows are illuminated to create the first image on the object 22.

As shown in FIG. 10, the first nine rows of the light sources 24 are shown illuminated. The light emitting from the 1^{st}, 4^{th}, and 7^{th} rows of light sources 24 are illustrated as solid lines. As is known in the art, light emitting through the center of the lens 42 for each of the light sources 24 passes straight through without refraction to define an opposed image on the object 22. Light from each of the light sources 24 emitting through the grooves 44 in the lens 42 is refracted to align with the associated opposed image. Hence, for example, all of the light projecting from the first or top row of light sources 24 is focused and refracted into a single opposed image on the bottom of the object 22.

The focused and refracted light then passes through the diffuser 46. The focused light becomes blurred as the light passes through the diffuser 46. In particular, the light exiting the lens 42 from the rows of LEDs 26 is a series of dots, i.e. three dots correlating to the three LEDs 26 of the first row. The three dots are then blurred by the diffuser 46 such that the image projected onto the object 22 is a line. The focused, refracted, and blurred light is now projected upon the object 22 to create a first image on the object 22.

The use of a lens 42 creates additional advantages over the prior art grating systems in that the light sources 24 typically do not have to be as intense. This phenomenon occurs because of the amount of light throughput, which defines the amount of light passing through the imaging device 40. In a grating system, as discussed in the background section, only half of the light from the light sources 24 passes through the grate. In an imaging system 20 utilizing a lens 42, all of the light from the light sources 24 passes through the lens 42 and is projecting onto the object 22. Hence, less intense or fewer light sources 24 can be used to achieve the same result such that all of the illuminated rows outlined above may not be necessary to achieve the desired image.

The first image is subsequently captured by the sensor 30 in the camera 28 and saved in the memory of the processor 32. After the first image is captured and saved, the light emitting diodes 26 of the first row, and each subsequent row, in the matrix are deactivated.

Referring to FIGS. 8 and 10, the light emitting diodes 26 of a second row of the light matrix are illuminated to project light toward the lens 42. nd Preferably, the second image is be created by simultaneously illuminating the 2^{nd}, 5^{th}, 8^{th}, 11^{th}, 14^{th}, 17^{th}, 20^{th}, 23^{rd}, and 26^{th} rows. As shown in FIG. 10 the light emitting from the 2^{nd}, 5^{th}, and 8^{th} rows of light sources 24 are illustrated as long dashed lines. As discussed above, light emitting through the center of the lens 42 passes straight through without refraction to define an opposed image on the object 22. Light from, for example the 2^{nd} row of lights, is focused and refracted into a single opposed image on the object 22.

As with the first row of light sources 24, the focused and refracted light then passes through the diffuser 46. The focused light becomes blurred as the light passes through the diffuser 46. The focused, refracted, and blurred light from the second row is now projected upon the object 22 to create a second image on the object 22. The second image is then captured and saved to the memory of the processor 32.

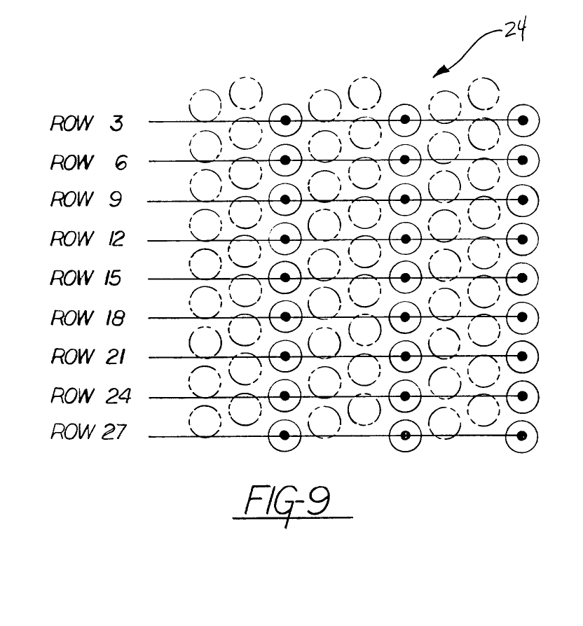

The process is repeated with the third row of lights wherein the illumination of the 3^{rd}, 6^{th}, and 9^{th} rows of light sources 24 are illustrated as short dashed lines in FIG. 10. The third image is subsequently captured and saved to the processor 32. As with the first and second images, the third image is preferably created by simultaneously illuminating the 3^{rd}, 6^{th}, 9^{th}, 12^{th}, 15^{th}, 18^{th}, 21^{th}, 24^{th}, and 27^{th} rows, as illustrated in FIG. 9.

This process can be continuously repeated as is deemed necessary. It is to be understood that the modulating or shifting of the images as described above can be achieved by any number of combinations of rows. For instance, the shifting of the images could be obtained by illuminating rows 1, 2, 4, 5, 7, 8 . . . and so forth for the first image; illuminating rows 2, 3, 5, 6, 8, 9 . . . and so forth for the second image; and finally illuminating rows 3, 4, 6, 7, 9, 10 . . . and so forth for the third image. As also discussed above, there may be any suitable number of illuminated rows as are deemed necessary.

The particular lighting sequence chosen would create three different images shifted by a known periodic phase. The periodic phase that the images is shifted is established by the relationship between the spacing of the rows in the light matrix, the distance between the light matrix and the imaging device 40, distance O, and the distance between the imaging device 40 and the object 22, distance I.

The processor 32 converts the information from the captured images into a three-dimensional bit map of the object 22. The three-dimensional bit map is created by utilizing three or more captured images which where projected on the object 22 while shifting the periodic phase of the projected images. This process is known to those skilled in the art as Phase Shifting Interferometry and is disclosed in U.S. Pat. Nos. 4,641,972 and 4,212,073, which are hereby incorporated by reference to this specification.

An example of the operation of the subject invention is further described with reference to FIG. 11. FIG. 11 illustrates a panel 50 positioned at an unknown angle. The imaging system 20 is operated as is set forth above. Three different rows of light sources 24 are sequentially illuminated to provide three different images on the panel 50. For illustrative purposes, the illuminated rows of light sources 24 are shown as single lines.

As shown in FIG. 11, a top, center, and bottom row of lights are illuminated. The top row of light sources 24 project light through the lens 42 and diffuser 46 and is refracted to portray an image on the bottom of the panel 50. Conversely, the bottom row of light sources 24 project light through the lens 42 and diffuser 46 and is refracted to portray an image on the top of the panel 50. The center row of light sources 24 project light through the lens 42 and diffuser 46 to portray an image on the center of the panel 50. The shift created between the top, center, and bottom row of light sources 24 is known.

The camera 28 of the imaging system 20 then captures the three images having three shifted periodic phases.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims the invention may be practiced otherwise than as specifically described.

What is claimed is:

1. An imaging system for creating a three dimensional image of an object, said system comprising;
a housing,
at least three light sources mounted to said housing and being selectively illuminated for projecting light on the object,
a camera spaced from said housing for capturing projected light reflecting from the object,
an imaging device mounted to said housing and spaced from said light sources for focusing the projected light to define an image projected upon the object, and
a controller connected to said light sources for sequentially illuminating said light sources to produce at least three different images on the object and connected to said camera for controlling said camera to capture the different images for creating the three dimensional image of the object.

2. An imaging system as set forth in claim 1 wherein said imaging device includes a lens for focusing the projected light to create the image.

3. An imaging system as set forth in claim 2 wherein said lens is further defined as a fresnel lens having a series of concentric grooves which act as individual refracting surfaces.

4. An imaging system as set forth in claim 3 wherein said fresnel lens is mounted to said housing such that said grooves face inward toward said light source.

5. An imaging system as set forth in claim 3 wherein said fresnel lens is mounted to said housing such that said grooves face outward away from said light source.

6. An imaging system as set forth in claim 2 wherein said imaging device further includes a diffuser for blurring the image projected onto the object.

7. An imaging system as set forth in claim 6 wherein said diffuser is further defined as a lenticular lens having an array of aligned cylindrical lenses, as viewed in cross section.

8. An imaging system as set forth in claim 7 wherein said diffuser is mounted to said housing such that said cylindrical lenses face inward toward said light sources.

9. An imaging system as set forth in claim 1 further including a sensor mounted within said camera for viewing the object and capturing each of the images produced by said matrix of light sources.

10. An imaging system as set forth in claim 9 further including a processor interconnected to said camera for converting the images of the object projected thereon into a three-dimensional bit map of the object.

11. An imaging system as set forth in claim 9 wherein said sensor includes a two-dimensional imaging array.

12. An imaging system as set forth in claim 9 wherein said sensor includes a line scan sensor defining a one-dimensional imaging array for producing a bit map along a single line.

13. An imaging system as set forth in claim 9 wherein said sensor includes a single detector for producing a bit map at a single point.

14. An imaging system as set forth in claim 1 wherein said light sources are further defined as a plurality of light sources arranged in at least three rows to define a matrix of light sources.

15. An imaging system as set forth in claim 14 wherein said rows of light sources are formed of discreet point light sources defined by light emitting diodes.

16. An imaging system as set forth in claim 1 wherein said light sources are further defined as a plurality of at least three slab diode lasers.

17. An imaging system as set forth in claim 1 wherein said light sources are further defined as a plurality of at least three horizontally oriented light stripes which emit a line of light.

18. An imaging system as set forth in claim 1 wherein said light sources are discreet point light sources defined by light emitting diodes.

19. An imaging system as set forth in claim 1 wherein said light sources are discreet point light sources defined by laser diodes.
